(19) United States
(12) Patent Application Publication
(10) Pub. No.: US 2006/0177654 A1
(43) Pub. Date: Aug. 10, 2006

(54) Pressure sensitive adhesive sheet for protecting surface and method for production thereof

(76) Inventor: Satoru Shoshi, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 10/549,668

(22) PCT Filed: Mar. 16, 2004
(86) PCT No.: PCT/JP04/03484

§ 371 Date: Sep. 19, 2005

(30) Foreign Application Priority Data
Mar. 17, 2003 (JP) 2003072775

(51) Int. Cl. B32B 7/12

(52) U.S. Cl. 428/354; 428/343

(57) ABSTRACT

The present invention relates to a pressure sensitive adhesive sheet for protecting a surface, which has a structure that a pressure sensitive adhesive layer, a cured urethane (meth)acrylate layer, a hard coat layer and optionally a protect film are laminated in order, and a method for producing said sheet, which comprises applying a urethane(meth)acrylate on the surface of a releasing agent layer of a plastic film having the releasing agent layer, followed by curing, to form a cured urethane(meth)acrylate layer, applying a hard coat agent on the surface of the cured urethane(meth)acrylate layer, followed by curing, to form a hard coat layer, laminating a process film on the surface of the hard coat layer, and then peeling the above plastic film having a releasing agent layer, and subsequently forming a pressure sensitive adhesive layer on the exposed surface of the cured urethane(meth)acrylate layer. The pressure sensitive adhesive sheet for protecting a surface of the present invention can give excellent scratch resistance, water resistance and chemical resistance to the surface of image papers such as a photograph output by a printer and a display, can be reduced in distortion, and can achieve an improved definition of an image and the reduction of the thickness of the pressure sensitive adhesive sheet for protecting a surface.

### FIELD OF THE TECHNOLOGY

The present invention relates to a pressure sensitive adhesive sheet for protecting a surface which can laminate to the surface of an image paper such as a photograph output by a printer such as a color printer and a display, and a method for production thereof.

### BACKGROUND TECHNOLOGY

In recent years, technological innovation in color printers progresses remarkably. The definition of image and fineness of the image such as the photograph output by the color printer are already the same level as developed film photographs. But, there are problems that the image such as the photograph output by the color printer is inferior in abrasion resistance, water resistance and chemical resistance of the surface compared with the developed film photograph. Further, as the image paper such as the photograph output by the color printer has a wide area, the abrasion resistance, the water resistance and the chemical resistance of the surface have been required more strongly.

For responding the demand, there is an idea that a protecting film is laminated to the surface of the image paper such as the photograph output by the color printer. As the conventional protecting films, pressure sensitive adhesive sheets for protecting a surface having a hard coat layer on the surface of a transparent plastic film and an adhesive layer on the back surface of the transparent plastic film are proposed (referred to, for example, JP2001-260549A).

For protecting the surface of displays such as LCD (liquid crystal display), PDP (plasma display) and CRT (cathode-ray tube), from dust, stain, flaw and et. al., and further, providing water resistance and chemical resistance, there is an idea that the protecting film is laminated to the surface of the displays.

However, when the conventional pressure sensitive adhesive sheets for protecting a surface are used as the protecting film, there was a problem that visibility decreases by distortion and et. al. of the stretch-formed substrate film, because the conventional pressure sensitive adhesive sheets for protecting a surface have an adhesive layer formed on the stretch-formed substrate film.

And, if the abrasion resistance is given to the surface of the conventional pressure sensitive adhesive sheets for protecting a surface, it is needed to form the hard coat layer to the stretch-formed substrate film. Therefore, there was a problem that the definition of image is insufficient, because the lubricant used in producing the film of the substrate film is left on the surface of the substrate film, and defects are caused in the hard coat layer by protrusion of the left lubricant.

### DISCLOSURE OF THE INVENTION

An object of the present invention is to provide a pressure sensitive adhesive sheet for protecting a surface which can give excellent scratch resistance, water resistance and chemical resistance to the surface of image papers such as a photograph output by a printer and displays, can be reduced in distortion, and can achieve an improved definition of an image and the reduction of the thickness of the pressure sensitive adhesive sheet for protecting a surface.

Extensive investigations undertaken by the present inventors directed to the object described above have led to the discovery that the object can be achieved by forming a structure that a pressure sensitive adhesive layer, a cured urethane (meth)acrylate layer and a hard coat layer are laminated in order, in view of a structure without the stretched substrate film in the state that the pressure sensitive adhesive sheet laminates to the adherend.

The present invention thus provides a pressure sensitive adhesive sheet for protecting a surface, which comprises a pressure sensitive adhesive layer, a cured urethane (meth)acrylate layer and a hard coat layer, wherein the layers are laminated in order.

In another aspect, the present invention provides the pressure sensitive adhesive sheet for protecting a surface as described above, wherein the cured urethane (meth)acrylate layer is formed by curing difunctional urethane (meth)acrylate having a weight average molecular weight of 2000 or more.

In another more aspect, the present invention provides the pressure sensitive adhesive sheet for protecting a surface as described above, wherein the thickness of the cured urethane (meth)acrylate layer is 2 to 30 micrometers, and the thickness of the hard coat layer is 2 to 20 micrometers.

Also, the present invention provides the pressure sensitive adhesive sheet for protecting a surface as described above, wherein the hard coat layer is a hard coat layer comprising a filler.

Further, the present invention provides a method for producing a pressure sensitive adhesive sheet for protecting a surface, which comprises applying urethane(meth)acrylate on a surface of a releasing agent layer in a plastic film having the releasing agent layer, followed by curing, to form a cured urethane(meth)acrylate layer, applying a hard coat agent on the surface of the cured urethane(meth)acrylate layer, followed by curing, to form a hard coat layer, laminating a process film on a surface of the hard coat layer, and then peeling the above plastic film having a releasing agent layer, and subsequently forming a pressure sensitive adhesive layer on the exposed surface of the cured urethane(meth)acrylate layer.

### PREFERABLE EMBODIMENT FOR PRACTICING THE INVENTION

The cured urethane (meth)acrylate layer in pressure sensitive adhesive sheet for protecting a surface of the present invention, can be formed by applying a curable composition containing urethane(meth)acrylate and then curing by irradiation of ionizing radiation such as ultraviolet ray and electron beam.

The urethane (meth)acrylate is a substance which can be cured by irradiation of ionizing radiation such as ultraviolet ray and electron beam.

The urethane (meth)acrylate includes (meth)acrylate in which a (meth)acryloil group is bonded through an urethane bonding to a polyol, and usually reaction products of a polyol, a diisocyanate and a hydroxyl group-containing (meth)acrylate.

The polyol includes polyether polyols and polyester polyols, and preferably polyether polyols. Also, the polyol includes aliphatic polyols and aromatic polyols, and preferably aliphatic polyols. The diisocyanate includes aliphatic diisocyanates, alicyclic diisocyanates and aromatic diisocyanates, and preferably aliphatic diisocyanates and alicyclic diisocyanates. The hydroxyl group-containing (meth)acrylate includes hydroxyaryl (meth)acrylates, hydroxyalkyl (meth)acrylates and hydroxycycloalkyl (meth)acrylates, and preferably hydroxyalkyl (meth)acrylates. The difunctional urethane (meth)acrylate includes difunctional urethane (meth)acrylates in which a diol is used as a polyol. The urethane (meth)acrylate can be utilized by single member or a combination of two or more members.

And, according to needs, polymerizable compounds such as vinyl compounds like styrene and vinyl pyrrolidone, (meth)acrylic acid ester and urethane (meth)acrylate having three or more functional groups can be used together with the urethane (meth)acrylate.

The urethane (meth)acrylate is preferably a difunctional urethane (meth)acrylate having a weight average molecular weight of 2000 or more. When the weight average molecular weight is less than 2000, cracking may be caused in the cured urethane (meth)acrylate layer in laminating the pressure sensitive adhesive sheet for protecting a surface to the curved surface. The weight average molecular weight of difunctional urethane (meth)acrylate is preferably in the range of 3000 to 20000, more preferably in the range of 5000 to 15000. The content of difunctional urethane (meth)acrylate is preferably 80 or more percents by mass, more preferably 90 or more percents by mass, and most preferably 95 or more percents by mass against to the total amount of difunctional urethane (meth)acrylate and other polymerizable compounds. The small amount of urethane (meth)acrylate having tri- or more functional groups can be used together with the difunctional urethane (meth)acrylate.

The curable composition containing the urethane (meth)acrylate can contains a photopolymerization initiator such as acetophenone, 1-hydroxycyclohexyl phenyl ketone, 2-methyl-1-[4-(methylthio)phenyl]-2-morpholynopropane-1-on, benzoin methyl ether, and solvents such as toluene, 1-methoxy-2-propanol, isopropyl alcohol, methyl isobutyl ketone and ethyl cellosolve.

In the present invention, the cured urethane (meth) acrylate layer has preferably transparency for improving the definition of image.

In the method for producing a pressure sensitive adhesive sheet for protecting a surface of the present invention, the cured urethane (meth)acrylate is formed by applying a curable composition containing urethane(meth)acrylate on the surface of a releasing agent layer of a plastic film having the releasing agent layer, and then curing the applied urethane(meth)acrylate layer by irradiation of ultraviolet ray and the like.

The irradiation amount of the ultraviolet ray can be selected in the range of the amount at which the urethane(meth)acrylate can be cured, and is not limited particularly. The intensity of illumination is usually in the range of 50 to 300 mW/cm² and the quantity of light is usually in the range of 30 to 800 mJ/cm² by ultraviolet ray and the like.

The thickness of the cured urethane (meth)acrylate layer is preferably 2 to 30 micrometers, and more preferably 3 to 25 micrometers.

The plastic film used in the plastic film having the releasing agent layer includes, for example, films such as films of polyethylene resins such as high density polyethylene, middle density polyethylene and low density polyethylene; polypropylene resins such as polypropylene; polyolefin resin such as polymethyl-1-pentene/ethylene/cyclic olefin copolymer and ethylene-vinyl acetate copolymer; polyamide resins such as nylone-6, nylone-6,6, nylone-6,10 and nylone-6,12; polyester resins such as polyethylene terephthalate, polybutylene terephthalate, copolymer thereof, polyethylene naphthalate and aliphatic polyester; polycarbonate resins, polystyrene resins, polyphenylene sulfide resins, polyvinyl chloride resins, polyimide resins, fluorine resins, and copolymers containing one or more unit thereof, and polymer blends or polymer alloys containing resin described above. The films of polyester resins or polyolefin resins can be preferably used.

A thickness of the plastic film is not limited particularly, and usually in a range of from 10 to 300 micrometers.

The releasing agent layer of a plastic film having the releasing agent layer is composed of a releasing agent. As the releasing agent, various releasing agents can be used. The releasing agent includes alkyd resins, silicone resins and polyolefin resins and preferably alkyd resins and polyolefin resins. The releasing agent can be utilized by single member or a combination of two or more members.

The alkyd resin includes condensation polymer (straight alkyd resin) of glycerin and phthalic acid or phthalic acid anhydride, and modified alkyd resin which is a modified compound of straight alkyd resin. The modified alkyd resin includes acrylic-modified alkyd resin, rosin-modified alkyd resin, phenol-modified alkyd resin and urethane-modified alkyd resin. Among the alkyd resins, acrylic-modified alkyd resin is preferable.

The alkyd resin can contain silicone resin. When a mixture of alkyd resin and silicone resin is used, the formulating ratio of the alkyd resin is preferably in the range of 70 to 95 percents by mass.

The polyolefin resin includes polyethylene resin, polypropylene resin, ethylene-propylene copolymer resin and polybutene resin. Among the polyolefin resins, polyethylene resin is preferable.

A thickness of the releasing agent layer is usually in a range of not more than 30 micrometers, preferably in the range of 0.01 to 25 micrometers, and more preferably in the range of 0.1 to 20 micrometers.

If the surface of the releasing agent layer is fine irregularity shape, the cured urethane(meth)acrylate layer can have a surface of fine irregularity shape form. Accordingly, when the adhesive sheet is laminated to the image paper such as photograph, it is possible to be matting type pressure sensitive adhesive sheet for protecting a surface which can mat the surface of image of the photograph and the like. The surface roughness of the fine irregularity shape is preferably 0.15 to 0.5 micrometers, more preferably 0.2 to 0.4 micrometers in center line average height (Ra). The method for forming the fine irregularity shape to the surface of the releasing agent layer includes a method for providing emboss treatment to the surface of the releasing agent layer, and a method for applying the releasing agent to form a thin releasing agent layer on the surface having fine irregularity shape of the plastic film.

In the present invention, the hard coat layer is formed on the surface of the cured urethane(meth)acrylate layer.

The hard coat agent layer is composed of the cured substance of the hard coat agent.

The hard coat agent includes various curable hard coat agents such as thermosetting hard coat agent and ultraviolet curable hard coat agent, and preferably ultraviolet curable hard coat agent. The thermosetting hard coat agent includes silicone hard coat agent. The ultraviolet curable hard coat agent includes unsaturated monomer, oligomer, resin or compositions thereof which is ultraviolet curable hard coat agent which can be cured by irradiation of ultraviolet ray. The examples include polyfunctional ultraviolet curable acrylic compounds having three or more functional groups such as acrylates, urethane acrylates and polyester acrylates. Preferable examples include trimethylol ethane tri(meth)acrylate, trimethylol propane tri(meth)acrylate, pentaerythritol tri (meth)acrylate, pentaerythritol tetra(meth)acrylate, dipentaerythritol penta(meth)acrylate, dipentaerythritol hexa(meth)acrylate, glycerol tri(meth)acrylate and triallyl(meth)acrylate. The hard coat agent can be utilized by single member or a combination of two or more members.

The hard coat agent layer can be formed by applying the curable composition comprising the ultraviolet curable substance and curing by irradiation of ultraviolet ray.

A thickness of the hard coat layer is not limited particularly and usually preferably in a range of from 1 to 50 micrometers, more preferably in a range of from 2 to 30 micrometers, most preferably in a range of from 3 to 20 micrometers.

The hard coat agent can be formulated with a filler. It is possible to give nonglaring property by containing the filler.

The filler includes inorganic filler and organic filler. The inorganic filler includes inorganic oxides such as silica, alumina and titaninum oxide. Preferable example are gels of these inorganic oxides. The organic filler includes crosslinked polymethyl methacrylate, polyethylene microparticulate, polystyrene microparticulate and silicone powder.

The particle size of the filler is preferably smaller. The average particle size is more preferably in the range of 0.3 to 5 micrometers.

The content of the filler is preferably 0.1 to 20 percents by mass, more preferably 1 to 10 percents by mass against to the hard coat agent layer. By containing such filler in the hard coat layer, it is possible to obtain the pressure sensitive adhesive sheet for protecting a surface having proper nonglaring property in the range of 3 to 30 percents in haze value.

The hard coat agent can contain a thermosetting catalyst, photopolymerization initiator and a solvent according to needs. As the thermosetting catalyst, various acid catalysts can be utilized. Examples include hydrochloric acid and sulfuric acid. The photopolymerization initiator and the solvent include the same as described above.

The preferable hard coat layer has high hardness of the surface.

In the present invention, in order to improve the definition of image, the preferable hard coat layer has transparency.

In the method for producing a pressure sensitive adhesive sheet for protecting a surface of the present invention, the hard coat layer is formed by applying a hard coat agent on the surface of the cured urethane(meth)acrylate layer, followed by curing. When the hard coat agent is the ultraviolet curable hard coat agent, the hard coat layer is formed by applying the ultraviolet curable hard coat agent and curing by irradiation of ultraviolet ray to the applied film. The irradiation amount of ultraviolet ray used for curing the ultraviolet curable hard coat agent is the same as described above.

A thickness of the hard coat layer is preferably in a range of from 2 to 20 micrometers, more preferably in a range of from 3 to 15 micrometers.

The protecting film can be laminated on the surface of the hard coat layer according to needs. The protecting film is used to protect the pressure sensitive adhesive sheet for protecting a surface in carrying the pressure sensitive adhesive sheet for protecting a surface of the present invention or laminating to the adherend, or as process film in the production of the pressure sensitive adhesive sheet for protecting a surface.

The protecting film includes a protecting film in which the pressure sensitive adhesive layer is formed on the surface of the plastic film.

The plastic film includes that as described above. The preferable examples are the same as described above. The preferable surface of the plastic film is surface-treated for increasing the adhesion strength to the pressure sensitive adhesive layer.

The pressure sensitive adhesive used in the pressure sensitive adhesive layer includes the same adhesives as described later. The pressure sensitive adhesion strength of the preferable pressure sensitive adhesive is small to peel easily the pressure sensitive adhesive layer of the protecting film in the interface of the pressure sensitive adhesive layer and the hard coat layer after laminating the pressure sensitive adhesive sheet for protecting a surface to the adherend. The pressure sensitive adhesion strength is preferably in the range of 0.1 to 2 mN/25 mm, more preferably in the range of 0.15 to 1 mN/25 mm. In the present specification, the pressure sensitive adhesion strength is a value measured by the method based on JIS (Japanese industrial standard) Z 0237. A thickness of the pressure sensitive adhesive layer is preferably in a range of from 3 to 50 micrometers, more preferably in a range of from 5 to 30 micrometers.

For laminating the protecting film on the surface of the hard coat layer, the surface of the pressure sensitive adhesive layer of the protecting film may be laminated to the surface of the hard coat layer.

In the present invention, the pressure sensitive adhesive layer is formed on the opposite side of the cured urethane(meth)acrylate layer against to the surface on which the hard coat layer is formed.

The pressure sensitive adhesives used in the pressure sensitive adhesive layer include natural rubber pressure sensitive adhesives, synthetic rubber pressure sensitive adhesives, acrylic resin pressure sensitive adhesives, polyvinyl ether resin pressure sensitive adhesives, urethane resin pressure sensitive adhesives and silicone resin pressure sensitive adhesives. The examples of the synthetic rubber pressure sensitive adhesives include styrene-butadiene rubber, polyisobutylene rubber, isobutylene-isoprene rubber, isoprene rubber, styrene-isoprene block copolymer, styrene-butadiene block copolymer, styrene-ethylene-butylene block copolymer and ethylene-vinyl acetate thermoplastic elastomer. The examples of the acrylic resin pressure sensitive adhesives include homopolymers or copolymers of acrylic acid, methyl acrylate, ethyl acrylate, propyl acrylate, butyl acrylate, 2-ethylhexyl acrylate, methyl methacrylate, ethyl methacrylate, butyl methacrylate, or acrylonitrile. The examples of the polyvinyl ether resin pressure sensitive adhesives include polyvinyl ether and polyvinyl isobutyl ether. The examples of the silicone resin pressure sensitive adhesives include dimethylpolysiloxane. The pressure sensitive adhesives can be utilized by single member or a combination of two or more members.

The pressure sensitive adhesive layer can contain a tackifier, a softener, an antioxidant, a filler, a colorant of dye or pigment according to needs. The tackifier includes rosin resins, terpene phenol resins, terpene resins, aromatic hydrocarbon-modified terpene resins, petroleum resin, coumarone-indene resins, styrene resins, phenol resins and xylene resins. The softener includes process oils, liquid rubbers and plasticizers. The filler includes silica, talc, clay and calcium carbonate.

The pressure sensitive adhesion strength of the pressure sensitive adhesive layer is preferably in the range of 2 to 30 mN/25 mm, more preferably in the range of 5 to 25 mN/25 mm.

A thickness of the pressure sensitive adhesive layer is preferably in a range of from 5 to 50 micrometers, more preferably in a range of from 10 to 30 micrometers.

In the method for producing a pressure sensitive adhesive sheet for protecting a surface of the present invention, after peeling the plastic film having a releasing agent layer which is used in the formation of the cured urethane(meth)acrylate layer, the pressure sensitive adhesive layer is formed on the exposed surface of the cured urethane(meth)acrylate layer.

The pressure sensitive adhesive layer can be formed by applying the pressure sensitive adhesive directly on the cured urethane(meth)acrylate layer, or by laminating a release liner having a pressure sensitive adhesive layer and the plastic film having the cured urethane(meth)acrylate layer after forming the pressure sensitive adhesive layer by applying pressure sensitive adhesive on the surface of the releasing agent layer in the release liner and then drying. The method for forming the pressure sensitive adhesive layer is not limited particularly, and various methods can be used. The method for forming the pressure sensitive adhesive layer includes, for example, air knife coater, blade coater, bar coater, gravure coater, roll coater, curtain coater, die coater, knife coater, screen coater, Meyer bar coater, kiss coater and the like.

In the present invention, the preferable pressure sensitive adhesive layer has transparency to improve the definition of image.

The surface of the pressure sensitive adhesive layer can be covered with a release liner.

As the release liner, various release liners can be used. The release liner includes, for example, substrate materials composed of films of any one or more of various resins such as polyethylene terephthalate, polybutylene terephthalate, polyethylene, polypropylene and polyarylate; any one or more of various papers such as polyethylene-laminated paper, polypropylene-laminated paper, clay-coated paper, resin-coated paper and glassine paper; and release-treated substrate materials according to needs wherein the laminating surface against to the pressure sensitive adhesive layer is release-treated.

In this case, typical examples of release-treatment are formations of a release agent layer composed of a releasing agent such as silicone resin, long-chain alkyl-containing resin and fluorine resin.

A thickness of the release liner is not limited particularly and can be selected properly.

The preferable method for producing a pressure sensitive adhesive sheet for protecting a surface of the present invention is a method which comprises applying urethane(meth)acrylate on the surface of a releasing agent layer of a plastic film having the releasing agent layer, followed by curing, to form a cured urethane(meth)acrylate layer, applying a hard coat agent on the surface of the cured urethane(meth)acrylate layer, followed by curing, to form a hard coat layer, laminating a process film on the surface of the hard coat layer, and then peeling the above plastic film having a releasing agent layer, and subsequently forming a pressure sensitive adhesive layer on the exposed surface of the cured urethane(meth)acrylate layer.

As the process film, the protecting films as described above can be used. By using the process film, the working effectiveness of the formation of the pressure sensitive adhesive layer is good, because slacking or elongation is not caused in the cured urethane(meth)acrylate layer, when the plastic film having the releasing agent layer is peeled.

When the surface of the pressure sensitive adhesive layer in the adhesive sheet is covered with the release liner, the laminating of the pressure sensitive adhesive sheet for protecting a surface of the present invention to the adherend, can be conducted by peeling the release liner and sticking the pressure sensitive adhesive layer to the surface of the adherend.

When the protecting film is laminated after laminating the pressure sensitive adhesive sheet for protecting a surface to the adherend, the laminate composed of the hard coat layer and the cured urethane(meth)acrylate layer on the surface of the adherend can be formed by removing the protecting film.

The pressure sensitive adhesive sheet for protecting a surface of the present invention can be laminated to the surface of image papers such as a photograph or the most outer surface of a display or a touch panel, and also can be used for protection by laminating each inner member in LCD or touch panels.

### EXAMPLES

The present invention is described more specifically by reference to embodiments thereof. It should be noted that the present invention is not intended to be limited by these embodiments.

### Example 1

<Preparation of Ultraviolet Curable Urethane Acrylate Composition A>

One hundred parts by weight of urethane acrylate having difunctional groups (produced by NIPPON SYNTHETIC CHEMICAL INDUCSTRY Co., Ltd., tradename “SHIKO UV-3520TL”, weight average molecular weight 14000, solid concentration 70 percents by weight) and 3.5 parts by weight of 1-hydroxy-cyclohexyl-phenyl-ketone (produced by CIBA SPECIALITY CHEMICALS CORPORATION, trade name “IRGACURE 184”) as the photopolymerization catalyst were mixed. And, into the mixture, a mixture liquid of toluene and ethyl cellosolve (weight ratio 1:1) as the diluent solvent was mixed to control the solid concentration to be 50 percents by weight. Thus, ultraviolet curable urethane acrylate composition A was prepared.

<Preparation of Hard Coat Agent Liquid C>

Into ultraviolet curable hard coat agent containing photopolymerization initiator (produced by ARAKAWA CHEMICAL INDUSTRIES Ltd., tradename “BEAMSET 575CB”, mixture of urethane acrylate and pentaerythritol triacrylate, solid concentration: 100 percents by weight), toluene as diluent solvent was added to prepare a hard coat agent having 50 percents by weight of solid content. Thus, hard coat agent liquid C was prepared.

<Preparation of Pressure Sensitive Adhesive Sheet for Protecting a Surface>

Ultraviolet curable urethane acrylate composition A described above was applied in the amount to form a film having cured thickness of 10 micrometers by Meyer bar No. 16 coater on the surface of the alkyd resin layer of release liner (produced by LINTEC Corporation, trade name “PET38AL-5”) in which an acrylic-modified alkyd resin layer (thickness 0.2 micrometers) was formed by applying acrylic-modified alkyd resin as a releasing agent on the surface of polyethylene terephthalate film (thickness 38 micrometers) and then drying. Subsequently, the applied ultraviolet curable urethane acrylate composition A layer was dried at 100° C. for 1 minute, and then, irradiated by ultraviolet ray (intensity of illumination 120 mW/cm², quantity of light 500 mJ/cm²) to form the ultraviolet-cured urethane acrylate layer.

Next, hard coat agent liquid C was applied in the amount to form a film having cured thickness of 5 micrometers by Meyer bar No. 16 coater on the surface of the ultraviolet-cured urethane acrylate layer, dried at 80° C. for 1 minute, and then, irradiated by ultraviolet ray (intensity of illumination 120 mW/cm², quantity of light 250 mJ/cm²) to form the hard coat layer.

Further, from a protecting film having a release liner (produced by LINTEC Corporation, trade name “AS PET38 M0003-27”, pressure sensitive adhesion strength 0.2 mN/25 mm) in which the acrylic pressure sensitive adhesive layer having thickness of 25 micrometers and the release liner having a silicone releasing agent layer were laminated in order, the release liner was peeled to remove. The acrylic pressure sensitive adhesive layer of the protecting film was laminated to the surface of the hard coat layer described above.

Furthermore, the release liner, in which the acrylic-modified alkyd resin layer was formed, was peeled. And a film in which an acrylic pressure sensitive adhesive layer (thickness 20 micrometers, pressure sensitive adhesion strength 20 N/25 mm) was formed by applying acrylic pressure sensitive adhesive (produced by LINTEC Corporation, trade name “PA-T1”) on the surface of a release liner (produced by LINTEC Corporation, trade name “SP-PET3811”, thickness 38 micrometers) in which silicone resin was applied on a polyethylene terephthalate film, was laminated on the exposed surface of the ultraviolet-cured urethane acrylate layer at the surface of the acrylic pressure sensitive adhesive layer. Thus, a pressure sensitive adhesive sheet for protecting a surface was prepared.

### Example 2

A pressure sensitive adhesive sheet for protecting a surface was prepared in the same method as described in Example 1, except that ultraviolet curable urethane acrylate composition B shown in the following was used instead of ultraviolet curable urethane acrylate composition A.

<Preparation of Ultraviolet Curable Urethane Acrylate Composition B>

One hundred parts by weight of urethane acrylate having difunctional groups (produced by KYOEISHA CHEMICAL Co., Ltd., trade name “UF-503LN”, weight average molecular weight 8000, solid concentration 70 percents by weight) and 3.5 parts by weight of 1-hydroxy-cyclohexyl-phenyl-ketone (produced by CIBA SPECIALITY CHEMICALS CORPORATION, trade name “IRGACURE 184”) as the photopolymerization initiator were mixed. And, into the mixture, a mixture liquid of toluene and ethyl cellosolve (weight ratio 1:1) as the diluent solvent was mixed to control the solid concentration to be 50 percents by weight. Thus, ultraviolet curable urethane acrylate composition B was prepared.

### Example 3

A pressure sensitive adhesive sheet for protecting a surface was prepared in the same method as described in Example 1, except that hard coat agent liquid D shown in the following was used instead of hard coat agent liquid C.

<Preparation of Hard Coat Agent Liquid D>

Into ultraviolet curable hard coat agent containing photopolymerization initiator (produced by Dainichiseika Color & Chemicals Mfg. Co., Ltd., trade name “SEIKABEAM EXF-01L”, solid concentration 100 percents by weight), 5 parts by weight of silica gel having average particle size of 1.4 micrometers (produced by FUJI SILYSIA CHEMICAL Ltd., trade name “SISILYA 310”) was added, and toluene as the diluent solvent was added to prepare a hard coat agent having 50 percents by weight of solid content. Thus, hard coat agent liquid D was prepared.

### Comparative Example 1

The hard coat agent liquid used in Example 1 was applied in the amount to form a film having cured thickness of 5 micrometers by Meyer bar No. 8 coater on the surface of polyethylene terephthalate film (produced by Toray Industries, Inc, thickness 50 micrometers) and then dried at 80° C. for 1 minute. Subsequently, the hard coat layer was irradiated by ultraviolet ray (intensity of illumination 120 mW/cm², quantity of light 250 mJ/cm²) to form the hard coat layer.

Next, a film in which an acrylic pressure sensitive adhesive layer (thickness 5 micrometers) was formed by applying acrylic pressure sensitive adhesive (produced by LINTEC Corporation, trade name “PA-T1”) on the surface of a release liner (produced by LINTEC Corporation, trade name “SP-PET3811”, thickness 38 micrometers) in which silicone resin was applied on a polyethylene terephthalate film, was laminated on the opposite side of the polyethylene terephthalate film against to the surface on which the hard coat layer is formed. And the pressure sensitive adhesive sheet for protecting a surface was prepared.

(Property Evaluation)

By evaluation methods described in the following, pressure sensitive adhesive sheets for protecting a surface obtained in examples and comparative examples were evaluated. The results of the evaluations were shown in Table 1.

(Haze and Total Light Transmittance)

The release liner of the pressure sensitive adhesive sheets for protecting a surface was peeled. The pressure sensitive adhesive sheets for protecting a surface was laminated on a glass plate having a thickness of 1 mm. And then, the protecting film was peeled. The haze and total light transmittance of the surface of the pressure sensitive adhesive sheets for protecting a surface was measured by using a haze meter (produced by NIPPON DENNSHOKU INDUSTRIES Co. Ltd., trade name “NDH 2000”) according to JIS K7105.

(60° Specular Gloss)

The release liner of the pressure sensitive adhesive sheets for protecting a surface was peeled. The pressure sensitive adhesive sheets for protecting a surface was laminated on a glass plate having a thickness of 1 mm. And then, the protecting film was peeled. The gloss at 60° of the surface of the hard coat layer was measured by using a gloss measurement machine (produced by NIPPON DENNSHOKU INDUSTRIES Co. Ltd., trade name “VG 2000” according to JIS K7105.

(Scratch Resistance Test)

The release liner of the pressure sensitive adhesive sheets for protecting a surface was peeled. The pressure sensitive adhesive sheets for protecting a surface was laminated on a glass plate having a thickness of 1 mm. And then, the protecting film was peeled. The surface of the hard coat layer was rubbed with Steel wool #0000 under load of 9.8×10⁻³N/mm². And then, condition of scratch was observed by visual and evaluated according to the following ranking.

◯: scratch was not observed.

X: scratch was observed.

(pencil hardness)

The pencil hardness of the surface of the hard coat layer was measured according to JIS K5600.

(Bending Resistance Property)

The release liner of the pressure sensitive adhesive sheets for protecting a surface was peeled. The pressure sensitive adhesive sheets for protecting a surface was wound around an iron bar having a diameter of 10 mm, as the surface of the hard coat layer was arranged outside. Next, the protecting film of the pressure sensitive adhesive sheets for protecting a surface was peeled. Cracking of the hard coat layer was observed by visual. Condition of cracking was evaluated according to the following ranking.

◯: cracking was not observed.

X: cracking was observed.

(visual definition of image)

The release liner of the pressure sensitive adhesive sheets for protecting a surface was peeled. The pressure sensitive adhesive sheets for protecting a surface was laminated on a surface of the image side of a color photograph printed by an inkjet color printer. And then, the protecting film of the pressure sensitive adhesive sheets for protecting a surface was peeled. Definition of image (such as variable photographic density) of photograph image was evaluated by visual at angle of 60°

TABLE 1

| | | | | Comparative |
|---|---|---|---|---|
| | Example 1 | Example 2 | Example 3 | Example 1 |
| Haze | 0.2 | 0.2 | 8.5 | 1.4 |
| Total light | 92.0 | 91.8 | 91.5 | 90.5 |
| transmittance | | | | |
| 60° specular | 160 | 158 | 85 | 162 |
| gloss | | | | |
| Scratch | ◯ | ◯ | ◯ | ◯ |
| resistance | | | | |
| Pencil hardness | H | H | H | H |
| Bending | ◯ | ◯ | ◯ | X |
| resistance | | | | |
| Visual definition | ⊚ | ⊚ | ◯ | X |
| of image | | | | |

⊚: definition of image was very good.
◯: definition of image was good.
X: definition of image was bad.

The pressure sensitive adhesive sheets for protecting a surface of the present invention in the Examples described above have superior hardness that the pencil hardness of the surface of the hard coat layer is not less than HB of preferable range, and particularly not less than H of more preferable range. The pressure sensitive adhesive sheets of the present invention have superior transparency that total light transmittance is not less than 80% of preferable range, not less than 85% of more preferable range, and not less than 90% of most preferable range. Also, The pressure sensitive adhesive sheets of the present invention are superior in bending resistance property and can give excellent scratch resistance, water resistance and chemical resistance to the surface of image papers such as a photograph output by a printer, can be reduced in distortion, and can achieve an improved definition of an image and the reduction of the thickness of the pressure sensitive adhesive sheet for protecting a surface.

What is claimed is:

1. A pressure sensitive adhesive sheet for protecting a surface, which comprises a pressure sensitive adhesive layer, a cured urethane (meth)acrylate layer and a hard coat layer, wherein the layers are laminated in order.

2. The pressure sensitive adhesive sheet for protecting a surface as claimed in claim 1, wherein the cured urethane (meth)acrylate layer is formed by curing difunctional urethane (meth)acrylate having a weight average molecular weight of 200 and more.

3. The pressure sensitive adhesive sheet for protecting a surface as claimed in claim 1, wherein the thickness of the cured urethane (meth)acrylate layer is 2- to 30 micrometers, and the thickness of the hard coat layer is 2 to 20 micrometers.

4. The pressure sensitive adhesive sheet for protecting a surface as claimed in claim 1, wherein the hard coat layer is a hard coat layer comprising a filler.

5. A method for producing a pressure sensitive adhesive sheet for protecting a surface, which comprises applying urethane (meth)acrylate on a surface of a releasing agent layer in a plastic film having the releasing agent layer, followed by curing, to form a cured urethane (meth)acrylate layer, applying a hard coat agent on the surface of the cured urethane (meth)acrylate layer, followed by curing, to form a hard coat layer, laminating a process film on a surface of the hard coat layer, and then peeling the above plastic film having a releasing agent layer, and subsequently forming a pressure sensitive adhesive layer on the exposed surface of the cured urethane (meth)acrylate layer
